(19) United States
(12) Patent Application Publication
(10) Pub. No.: US 2017/0274941 A1
(43) Pub. Date: Sep. 28, 2017

(54) ROAD VEHICLE AERODYNAMIC APPARATUS WITH SERRATED TRAILLING EDGE

(71) Applicant: TRANSTEX COMPOSITE INC., Montreal (CA)

(72) Inventors: Swaroop Mulenahalli KANTHARAJU, Toronto (CA); Mathieu BOIVIN, Montreal (CA); Georges BASSILY, Laval (CA)

(21) Appl. No.: 15/465,088

(22) Filed: Mar. 21, 2017

Related U.S. Application Data
(60) Provisional application No. 62/311,484, filed on Mar. 22, 2016.

(51) Int. Cl. B62D 35/00; B62D 37/02

(52) U.S. Cl. CPC B62D 35/001; B62D 35/007; B62D 37/02

(57) ABSTRACT

An apparatus for reducing air drag on a vehicle is hereby presented, the apparatus is comprising a panel including a surface thereof disposed between a first surrounding flow of air about the vehicle, on a first side of the panel, and a second surrounding flow of air about the vehicle, on a second side of the panel, the first surrounding flow of air being proximally located in respect with the longitudinal axis of the vehicle, the second surrounding flow of air being distally located in respect with the longitudinal axis of the vehicle, the first surrounding flow of air including a lower air velocity than the second surrounding flow of air, the panel including a serrated trailing edge thereof for creating vortexes and reducing air drag of the vehicle when the vehicle is moving forward.

### CROSS-REFERENCE

The present application is a non-provisional application of and claims priority from U.S. Provisional Patent Application No. 62/311,484, filed Mar. 22, 2016, entitled SINUOUS ROAD VEHICLE AERODYNAMIC APPARATUS TRAILLING EDGE. This document is incorporated herein by reference in its entirety.

### FIELD OF THE INVENTION

This invention relates to road vehicle aerodynamic apparatuses adapted to improve aerodynamic efficiency. The present invention more precisely relates to road vehicle aerodynamic apparatuses including a serrated trailing edge.

### BACKGROUND OF THE INVENTION

Road tractors are used to pull road trailers on roads to transport cargo. Aerodynamic apparatuses are installed on the road tractor and/or on the road trailer to reduce the aerodynamic air drag and improve fuel efficiency.

The aerodynamic apparatuses are installed on road tractors and/or road trailers in locations improving the air flow around the vehicle. These aerodynamic apparatuses can cause a vortex at their trailing edges. This vortex can have a significant effect on the resulting air drag.

Chevrons on aerodynamic apparatuses are already well known in the existing art for being used on airplane jet engines for, among other application, reducing noise, mixing hot air from the engine core and cooler air from the fan flow through the engine's duct and manipulating exhaust air from engine thrust to increase the rate of mixing cold air with hot air.

Therefore, there exists a need in the art for an improved aerodynamic apparatus over the existing art relating to road vehicle aerodynamic apparatuses. There is a need in the art for an improved aerodynamic apparatus that is reducing the vortex at its trailing edge. There is a need in the art for an improved aerodynamic apparatus that can be easily installed and economically manufactured.

### SUMMARY OF THE INVENTION

It is one aspect of the present invention to alleviate one or more of the drawbacks of the background art by addressing one or more of the existing needs in the art.

Accordingly, embodiments of this invention provide an improved road vehicle aerodynamic apparatus over the prior art that is using a serrated trailing edge at low velocity flow.

Embodiments of the invention provide a road vehicle aerodynamic apparatus that is sized and designed for reducing undesirable aerodynamic effects of straight trailing edge vortex on the air drag of the vehicle with serrated trailing edges to create small vortexes with smaller turbulence flow with low energy thereof.

Embodiments of the invention provide a road vehicle aerodynamic apparatus including a serrated, trailing edge for reducing undesirable aerodynamic effects of a trailing edge vortex at a wake region and reduce the air drag of the vehicle.

Embodiments of the invention provide a road vehicle aerodynamic apparatus including a serrated trailing edge of a separation member between a rapid distal flow of air (around the vehicle) and a proximal slower flow of air (under/behind the vehicle) for reducing undesirable aerodynamic effects of a separation member trailing edge vortex.

Embodiments of the invention provide a road vehicle aerodynamic apparatus including a serrated trailing edge for reducing undesirable aerodynamic effects of a trailing edge vortex by transforming one or many large vortexes into many smaller vortices of which the addition of the aerodynamic drag thereof is smaller than the addition of the one or many large vortexes.

Embodiments of the invention provide a road vehicle aerodynamic apparatus including a serrated trailing edge for reducing undesirable aerodynamic air drag effects of a trailing edge vortex by about 1.3%, and above, depending inter alia, on panel length and angles, and the speed of the vehicle.

Embodiments of the invention provide aerodynamic apparatuses for vehicle including means for breaking straight trailing edge on aerodynamic apparatuses panels for reducing aerodynamic drag. The means for breaking straight trailing edge on aerodynamic apparatuses panels could include, or denote, serrations, sinusoidal shaped edge, notched edge, chevrons and/or jagged edge, which define individual teeth or chevrons therebetween, a serrated trailing edge, laterally adjoining chevrons arranged in a row and extending aft from the aft end of the aerodynamic apparatuses, sinuous chevrons, among other possible configurations in line or other.

Embodiments of the invention provide a planar road vehicle aerodynamic apparatus member including an alternated trailing edge for reducing undesirable aerodynamic effects of a trailing edge vortex.

Embodiments of the invention provide a tail aerodynamic apparatus including serrated trailing edge on tail panels for reducing aerodynamic drag.

Embodiments of the invention provide aerodynamic skirts apparatuses including serrated trailing edge on skirt panels for reducing aerodynamic drag.

Embodiments of the invention provide an apparatus for reducing air drag on a vehicle, the apparatus comprising a panel including a surface thereof disposed between a first surrounding flow of air about the vehicle, on a first side of the panel, and a second surrounding flow of air about the vehicle, on a second side of the panel, the first surrounding flow of air being proximally located in respect with the longitudinal axis of the vehicle, the second surrounding flow of air being distally located in respect with the longitudinal axis of the vehicle, the first surrounding flow of air including a lower air velocity than the second surrounding flow of air, the panel including a serrated trailing edge thereof for creating vortexes and reducing air drag of the vehicle when the vehicle is moving forward.

Embodiments of the invention provide a vehicle comprising an apparatus for reducing air drag on a vehicle, the vehicle comprising a body including at least four wheels attached thereof and a longitudinal axis aligned with a forward direction of the vehicle, the apparatus comprising a panel including a surface thereof disposed between a first surrounding flow of air about the vehicle, on a first side of the panel, and a second surrounding flow of air about the vehicle, on a second side of the panel, the first surrounding flow of air being proximally located in respect with the longitudinal axis of the vehicle, the second surrounding flow of air being distally located in respect with the longitudinal axis of the vehicle, the first surrounding flow of air including a lower air velocity than the second surrounding flow of air, the panel including a serrated trailing edge thereof for creating vortexes and reducing air drag of the vehicle when the vehicle is moving forward.

Other embodiments and further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Additional and/or alternative advantages and salient features of the invention will become apparent from the following detailed description, which, taken in conjunction with the annexed drawings, disclose preferred embodiments of the invention.

### BRIEF DESCRIPTION OF THE DRAWINGS

Referring now to the drawings which form a part of this original disclosure:

FIG. 1 is a perspective rear-right view of a tractor and a trailer with an aerodynamic skirt assembly and an aerodynamic tail assembly secured thereto, in accordance with at least one embodiment thereof;

FIG. 2 is a left elevational view of the tractor of FIG. 1, in accordance with at least one embodiment thereof;

FIG. 3 is a bottom plan view of the tractor of FIG. 1, in accordance with at least one embodiment thereof;

FIG. 4 is a right-rear perspective view of an aerodynamic tail assembly, in accordance with at least one embodiment thereof;

FIG. 5 is a right-rear perspective view of an aerodynamic tail assembly, in accordance with at least one embodiment thereof;

FIG. 6A is a rear elevation view of an aerodynamic tail assembly, in accordance with at least one embodiment thereof;

FIG. 6B is a left elevation view of an aerodynamic tail assembly, in accordance with at least one embodiment thereof;

FIG. 6C is a top plan view of an aerodynamic tail assembly, in accordance with at least one embodiment thereof;

FIG. 6D is a magnified portion of a serrated trailing edge portion of an aerodynamic apparatus, in accordance with at least one embodiment thereof;

FIG. 7A is a rear elevation view of an aerodynamic tail assembly, in accordance with at least one embodiment thereof;

FIG. 7B is a right elevation view of an aerodynamic tail assembly, in accordance with at least one embodiment thereof;

FIG. 7C is a top plan view of an aerodynamic tail assembly, in accordance with at least one embodiment thereof;

FIG. 7D is a magnified portion of a serrated trailing edge portion of an aerodynamic apparatus, in accordance with at least one embodiment thereof;

FIG. 8 is a right-rear perspective view of an aerodynamic tail assembly, in accordance with at least one embodiment thereof;

FIG. 9 is a portion of a right-rear perspective view of an aerodynamic tail assembly, in accordance with at least one embodiment thereof;

FIG. 10A is a rear elevation view of an aerodynamic tail assembly, in accordance with at least one embodiment thereof;

FIG. 10B is a left elevation view of an aerodynamic tail assembly, in accordance with at least one embodiment thereof;

FIG. 10C is a top plan view of an aerodynamic tail assembly, in accordance with at least one embodiment thereof;

FIG. 10D is a magnified portion of a serrated trailing edge portion of an aerodynamic apparatus, in accordance with at least one embodiment thereof;

FIG. 11A is a top plan view of an aerodynamic tail assembly, in accordance with at least one embodiment thereof;

FIG. 11B is a rear elevation view of an aerodynamic tail assembly, in accordance with at least one embodiment thereof;

FIG. 12A is a left elevation view of aerodynamic skirt panel member, in accordance with at least one embodiment thereof;

FIG. 12B is a top plan view of aerodynamic skirt panel member, in accordance with at least one embodiment thereof;

FIG. 13 is a flow chart of a typical aerodynamic process, in accordance with at least one embodiment thereof;

FIG. 14 is a side elevation view of a trailer with a tail assembly;

FIG. 15 is aside elevation view of a trailer with a tail assembly, in accordance with at least one embodiment thereof; and

FIG. 16 is aside elevation view of a trailer with a tail assembly, in accordance with at least one embodiment thereof.

### DETAILED DESCRIPTION OF PREFERRED EMBODIMENTS

A preferred embodiment of the present invention is described below with reference to the drawings.

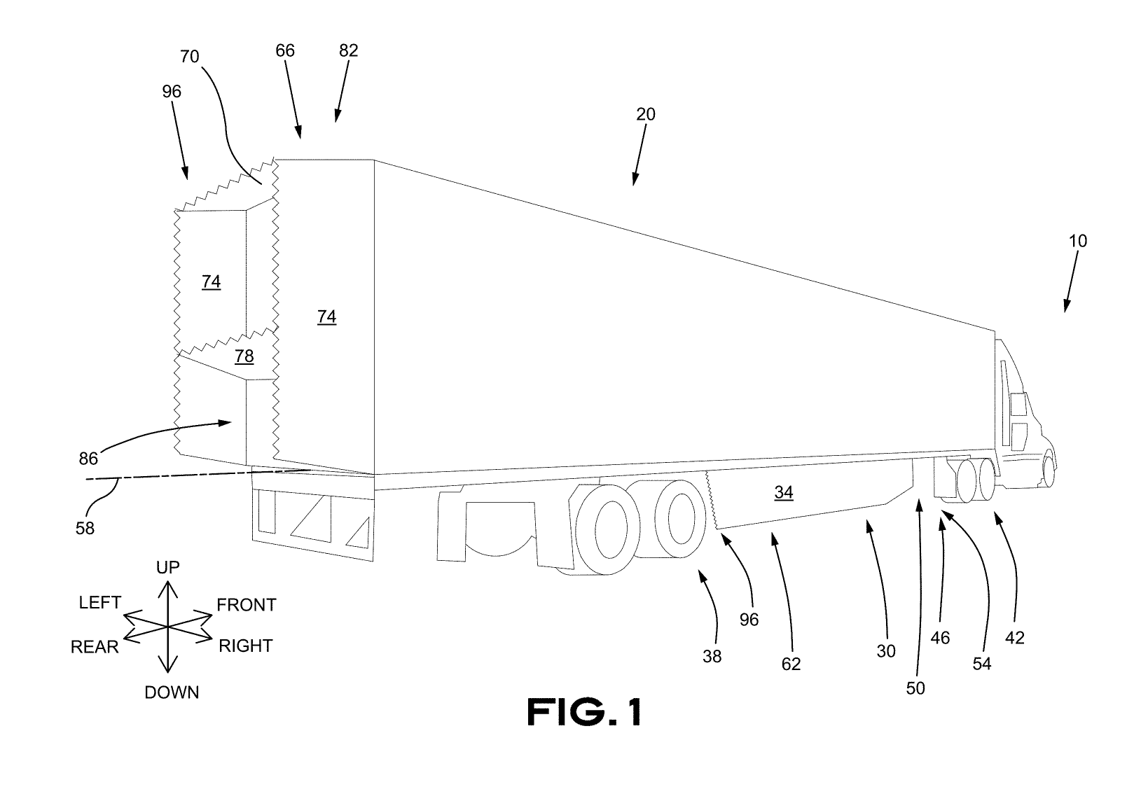

FIGS. 1, 2 and 3 illustrate a road tractor 10 with a road trailer 20 attached thereto equipped with a pair of skirt assemblies 30, installed on each side of the road trailer 20, adapted to deflect and direct the airflow 22 around the road trailer 20. The flow of air 22 moving around 24 (distally from the road trailer 20) the road trailer 20 is generally moving faster than the flow of air 22 moving under 26 or behind the road trailer 20 (proximally from the road trailer 20). Each skirt assembly 30 includes a skirt panel 34, adapted to be disposed on the lateral sides of the road trailer 20, and a plurality of securing members adapted to secure the skirt panel 34 to the road trailer 20. Once installed on the road trailer 20, the skirt assembly 30 helps channel the flow of air around the road trailer 20 to reduce the air drag of the vehicle when the road trailer 20 moves on the road, pulled by the road tractor 10.

The skirt assembly 30 of the present embodiment is mostly located under the road trailer 20, preferably vertically extending aligned from the side walls of the road trailer 20, between the wheels 38 of the road tractor 10 and the wheels 42 of the road trailer 20. The skirt panels 34 can alternatively extend forward to the trailer supports 46 of the road trailer 20, and be secured thereto, thus preventing complex skirt panel 34 arrangements through the trailer supports 14. The skirt panels 34 are substantially vertically positioned on each side of the road trailer 20 with a clearance with the ground by illustratively about 15-25 centimeters (about 6 to 10 inches). The air flow management around the trailer 20 provided by the skirt assembly 30 reduces the air drag created by the road trailer 20 by directing the flow of air around the road trailer 20. The flow of air would otherwise turbulently move around and below the road trailer 20 to create substantial air drag detrimental to the aerodynamic efficiency of the vehicle. The airflow management around the road trailer 20 provided by the skirt assembly 30 helps maintain laminar airflow around the road trailer 20 that benefits fuel economy of the road tractor 10. The skirt assembly 30 also improves the safety of the vehicle by providing a barrier that can significantly prevent foreign objects to get under the road trailer 20.

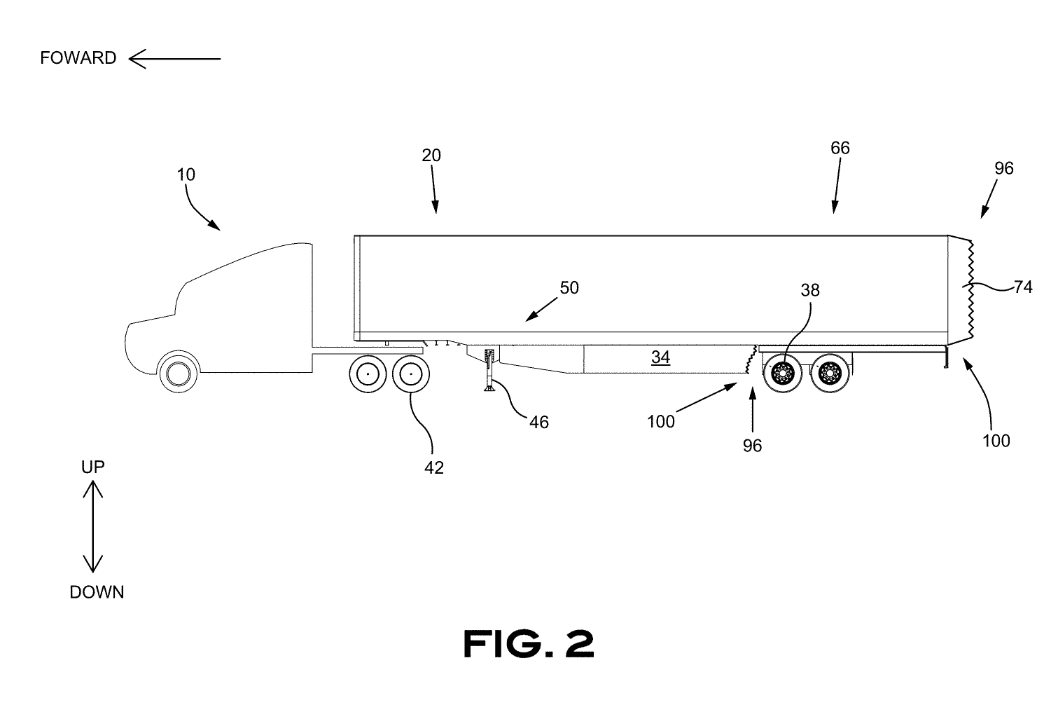

As illustrated in FIG. 2, the skirt panel 34 is shaped with an optional progressive height from the forwardmost portion 50. The skirt panels 34 can alternatively also be installed at an angle, in respect to the vertical, on the road trailer 20 to change the airflow pattern around the road trailer 20 and more precisely adjust the aerodynamics to a specific vehicle shape. One can appreciate the rear portion 62 of the skirt panels 34 are equipped with a plurality of serrations 96 to reduce vortexes and the air drag of the vehicle.

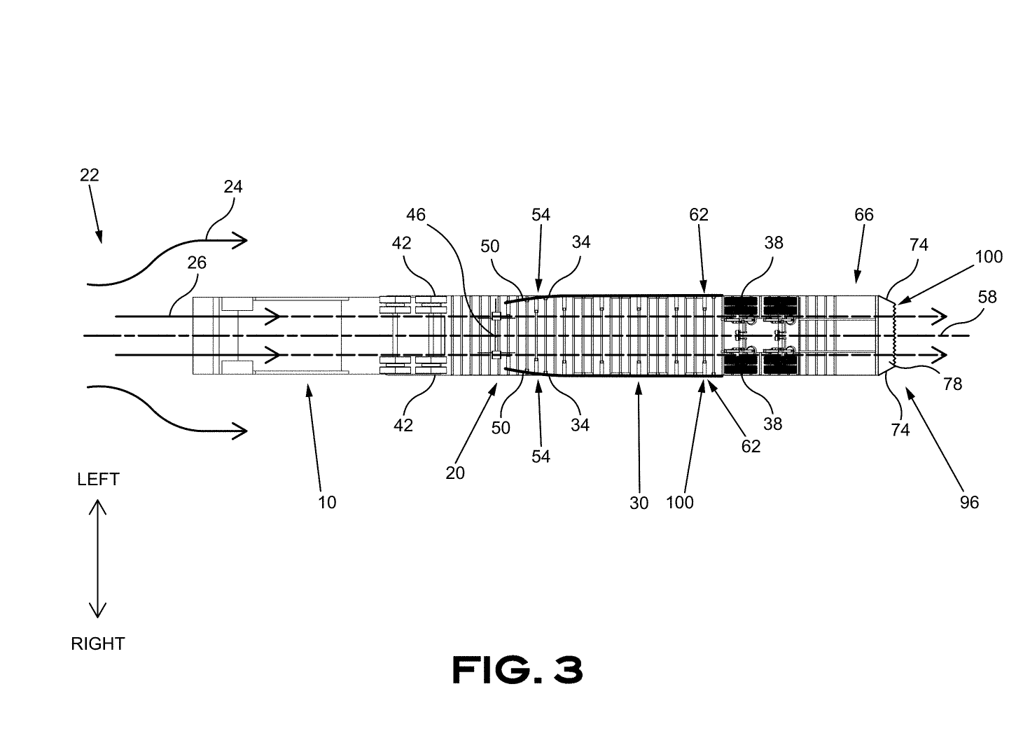

It can be appreciated from FIG. 3 that each skirt panel 34 is installed directly on the side of the road trailer 20 and, when seen from above, have a front portion 54 that progressively proximally leans toward the center 58 of the road trailer 20. The recessed front portion 54 of the skirt panel 34 improves the collection of turbulent airflow generated by the road tractor 10 thus improving the aerodynamic efficiency of the skirt assembly 30.

Generally, when a surface comes in contact with a fluid flow (gas or liquid) which has different speed with the fluid itself, a type of turbulent flow will be created at the end of the surface, the trailing edge of the surface. Like the flow end of moving boat on the water. This turbulence flow at the end of the surface is called wake region. The wake flow is a type of un-controlled energy like whirlwind. When we have a moving object in fluid, we know in advance that a wake region will be created. The main reason of the wake creation is the difference in the kinetic energy level of the flow in touch with a moving surface and the rest of surrounding flow. The surrounding flow does not want to have the same velocity as the moving object, so the flow creates a high resistance in respect with the moving object. Therefore, by getting a smoother energy transmission between the surrounded flow and the moving object smoother we can reduce the energy of wake region. Creating small vortexes, which are small turbulence flow with lower energy, is going to smoothen the energy transmission between the moving object and the surrounding fluid flow. The serrated geometry hence creates small vortexes. As a result, smoother energy transmission is obtained by small vortexes. The direction of energy transmission can be managed, by using specific pattern like the serrated trailing edge profile, and reduce the magnitude of turbulence energy with less turbulences and a more uniform fluid flow. The wakes and turbulences will be created at the back of the trailer 20 but it would not be close to the rear of the trailer 20. In other words, the wake region will be less significant in the balance of the aerodynamic forces because it is created further away from the trailing edge of the surface.

The road trailer 20 is including another aerodynamic apparatus referred to as an aerodynamic tail assembly 66. The aerodynamic tail assembly 66 can include an upper panel 70, a pair of side panels 74 and a lower panel 78. In embodiments thereof, the upper panel 70 and the lower panel 78 are providing little air drag reduction differences when they are less than 26″ of longitudinal length (in the longitudinal direction of the vehicle). Moreover, in some embodiments, the lower panel 78 can have a negligible drag-reducing effect. The aerodynamic tail assembly 66 can be optionally used without the lower panel 78. In order to dock the road trailer 20, the aerodynamic tail assembly 66 can be mounted on the road trailer 20 in an aerodynamic configuration 82 adapted to reduce the amount of drag created by the road trailer 20 and, conversely, a collapsed configuration (not illustrated) liberating the rear of the road trailer 20 to open the doors 86 of the road trailer 20 and dock the road trailer 20 to manage cargo therein.

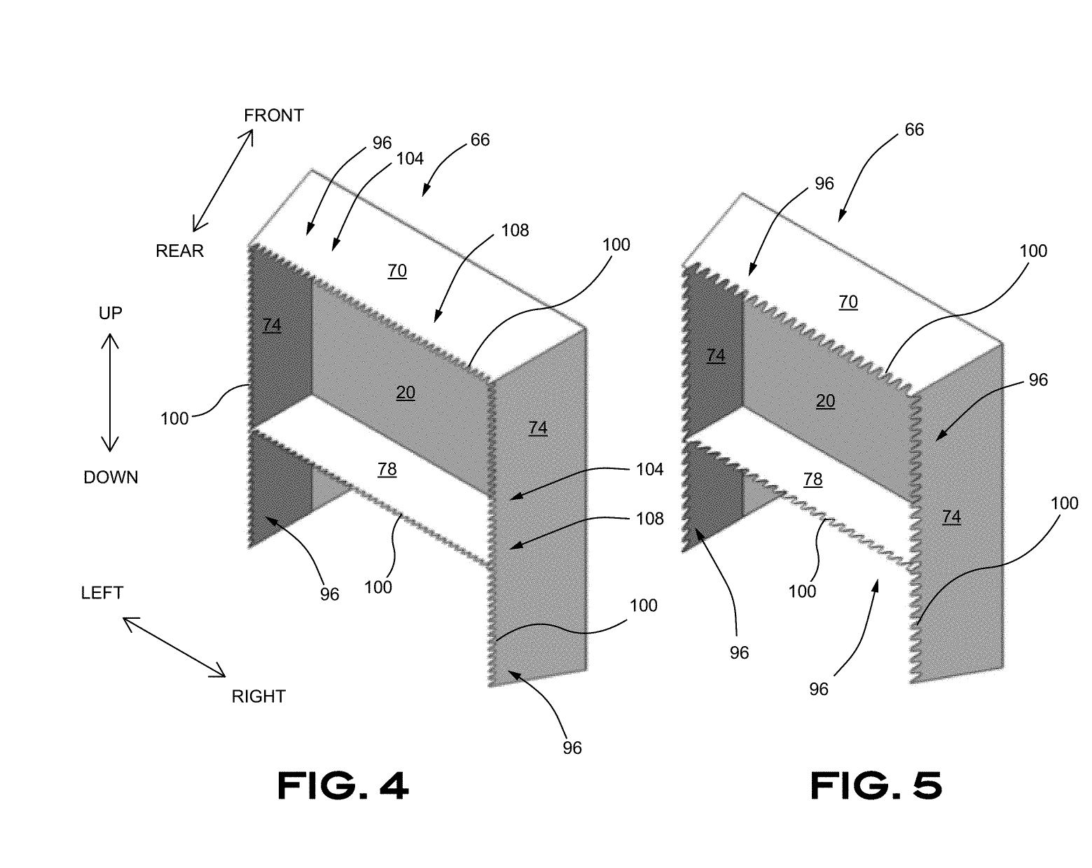

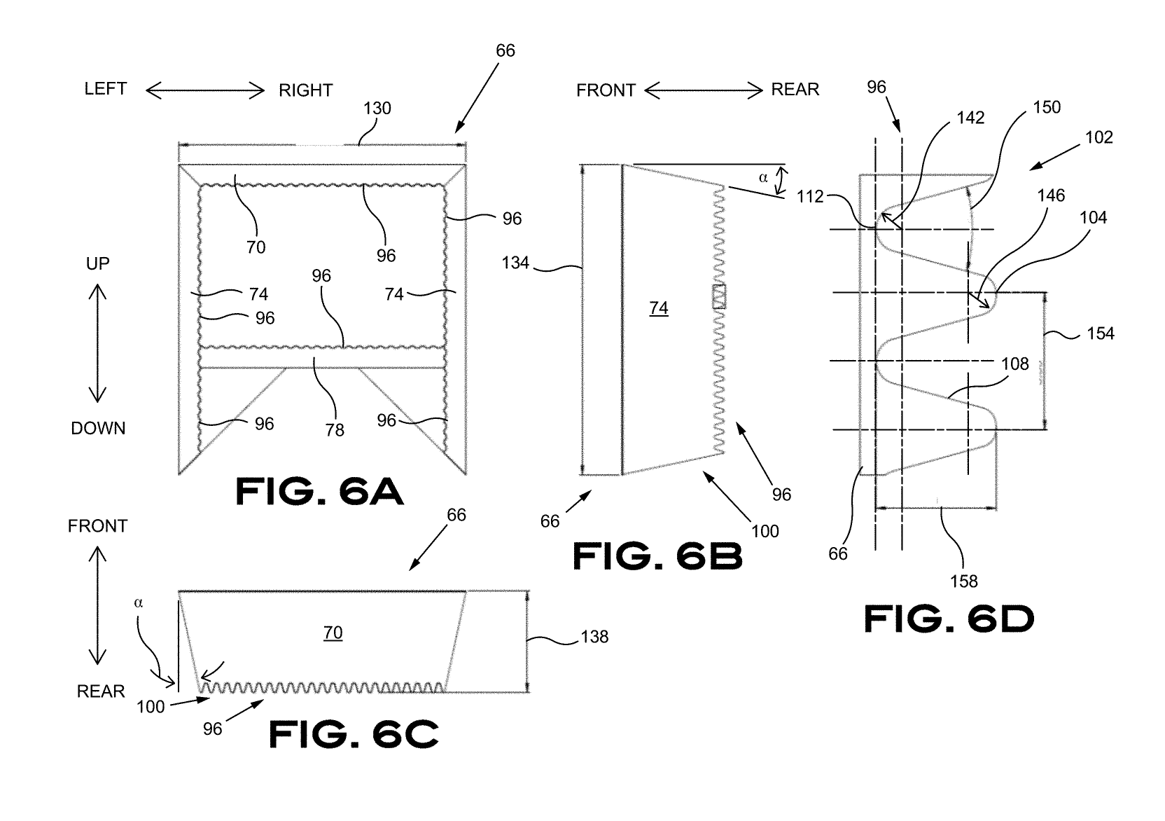

FIG. 4 and FIG. 5 are illustrating general embodiments of the aerodynamic tail assembly 66. The trailing edges 100 of the panels 70, 74, 78 include a plurality of laterally adjoining serrations 96 arranged in a row and extending aft from the aft end 108 of the panels 70, 74, 78. The illustrated embodiments depicted in FIG. 4 and FIG. 5 include a continuous series of serrations 96 on the trailing edges 100 of the panels 70, 74, 78; alternate embodiments could include serrations only on a portion of the panels 70, 74, 78. Serrations 96 could be disposed on a portion of the panels 70, 74, 78 or localized on some but not all the panels 70, 74, 78 without departing from the scope of the present application. One can appreciate the serrations 96 on the aerodynamic tail assembly 66 illustrated in FIG. 4 are smaller than the serrations 96 on the aerodynamic tail assembly 66 embodiment illustrated in FIG. 5. FIG. 6A illustrates a rear elevation view of the aerodynamic tail assembly 66 while corresponding side elevation view is depicted in FIG. 6B, a top plan view is illustrated in FIG. 6C and a magnified portion of the sinusoidal 102 serrations 96 is illustrated in FIG. 6D. A width 130 of the aerodynamic tail assembly 66, the height 134 of the aerodynamic tail assembly 66 and a length 138 of the panels 70, 74, 78 are also illustrated. Generally, the optimal width 130 of the aerodynamic tail assembly 66 is substantially equal to the width of the road trailer 20 and the height 134 of the aerodynamic tail assembly 66 can vary depending on the desired results however, the height 134 is generally comparable to the height of the road trailer 20. The longitudinal length 138 of the aerodynamic tail assembly 66 is adjusted in function of the desired aerodynamic effect and the ability of the aerodynamic tail assembly 66 to be docked to unload cargo from the trailer 20. The angle α between the upper panel 70 with the surface extension of the roof portion of the trailer, between the side panel 74 with the surface extension of the side wall of the trailer and between the lower panel 78 with the surface extension of the trailer 20 floor is material in the efficiency of the serrated tail assembly 66. The angle α is between about 5 degrees and 30 degrees in an embodiment. The angle α is between about 10 degrees and 20 degrees in another embodiment. The angle α is preferably between about 12 degrees and 17 degrees in embodiments thereof. The angle α is most preferably about 14 degrees in embodiments thereof. All the angles α above are contemplated in the present application and applicable to a variety of vehicle configurations.

The serrations 96 can have different shapes and provide drag-reducing results on the road trailer 20. Serrations 96 can be made of straight lines or curved lines without departing from the scope of this description. Sinuous serrations 102 are preferably arcuate or curved laterally around or along both sides of the serrations 102 apexes for each serration 102 with corresponding geometry. The trailing edges 108 of adjacent serrations 96 join together in laterally arcuate filets 112 extending circumferentially between adjacent serrations 96. In this way, the row of serrations 96 are laterally contiguous at their base with each other at the corresponding filets 112 and with the longitudinal trailing edges of the panels 70, 74, 78.

As best shown in FIG. 6D, the serrations 96 trailing edges 108 are preferably sinuous from the filets 112 aft in the downstream direction toward the corresponding serrations apexes 104. And, the trailing edges 100 are also sinuous from the serrations apexes 104 forward in the upstream direction toward the corresponding filets 112. In this way, the apexes 104 and fillets 112 themselves are suitably arcuate, and the trailing edge 100 continues the smooth arcuate profiles thereof along the opposite edges of each chevron between the bases and the apexes. The filets 112 radius 142, the apexes 104 radius 146, the internal angle 150, the intervening distance 154 between adjacent serrations 96 and the depth 158 of the serrations 96 can be adjusted without departing from the scope of the invention as illustratively indicated in Table 1.

TABLE 1

| | | | | | | Intervening | | | |
|---|---|---|---|---|---|---|---|---|---|
| | | | | | Internal | distance | | | |
| Configurations | Radius 142 | | Radius 146 | | angle 150 | 154 | | Depth 158 | |
| A | 6.35 | mm | 6.35 | mm | 30.6° | 54.5 | mm | 54.5 | mm |
| B | 6.35 | mm | 6.35 | mm | 30.6° | 95 | mm | 86 | mm |
| C | 16 | mm | 22.8 | mm | 21.25° | 95 | mm | 89 | mm |
| D | 19 | mm | 6.35 | mm | 47.9° | 190 | mm | 190 | mm |
| E | 19 | mm | 6.35 | mm | 39.36° | 127 | mm | 127 | mm |
| F | 12.7 | mm | 6.35 | mm | 35° | 76 | mm | 76 | mm |
| G | 25.4 | mm | 12.7 | mm | 15.9° | 101.6 | mm | 127 | mm |
| H | 25.4 | mm | 12.7 | mm | 15.9° | 150 | mm | 200 | mm |

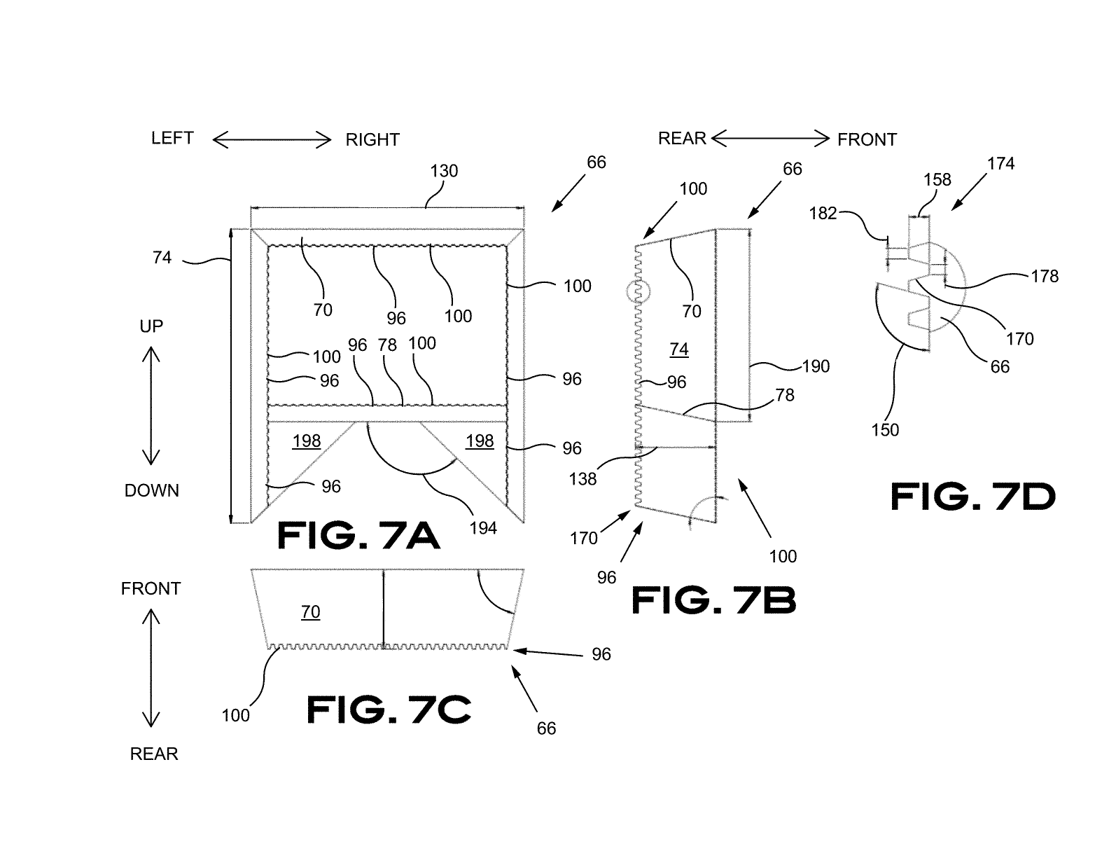

Another embodiment is illustrated in FIG. 7. The serrations 96 exemplified in FIG. 7 include a shape made of straight lines 170 instead of curved lines, as previously discussed. The straight chevrons 174 are designed with a depth 158 and an internal angle 150 comparable to the serrations 96 using straight lines. However, the radius 142 is replaced by internal chevrons width 178 and the radius 146 is replaced by external chevrons width 182. Some possible embodiments are indicated in Table 2 below. Further, the vertical location 190 of the lower panel is identified in respect with the upper panel 70 and the angle 194 in respect with panels 198 is also identified.

TABLE 2

| | | | | Intervening | | | |
|---|---|---|---|---|---|---|---|
| | | | Internal | distance | | | |
| Configurations | Width 178 | Width 182 | angle 150 | 154 | | Depth 158 | |
| H | 25.4 mm | 25.4 mm | 105° | 78 | mm | 49.5 | mm |
| I | 25.4 mm | 12.7 mm | 105° | 78 | mm | 76.2 | mm |
| J | 12.7 mm | 12.7 mm | 125° | 144.8 | mm | 76.2 | mm |
| K | 50.8 mm | 50.8 mm | 100° | 129.5 | mm | 76.2 | mm |
| L | 12.7 mm | 12.7 mm | 110° | 99 | mm | 101.6 | mm |

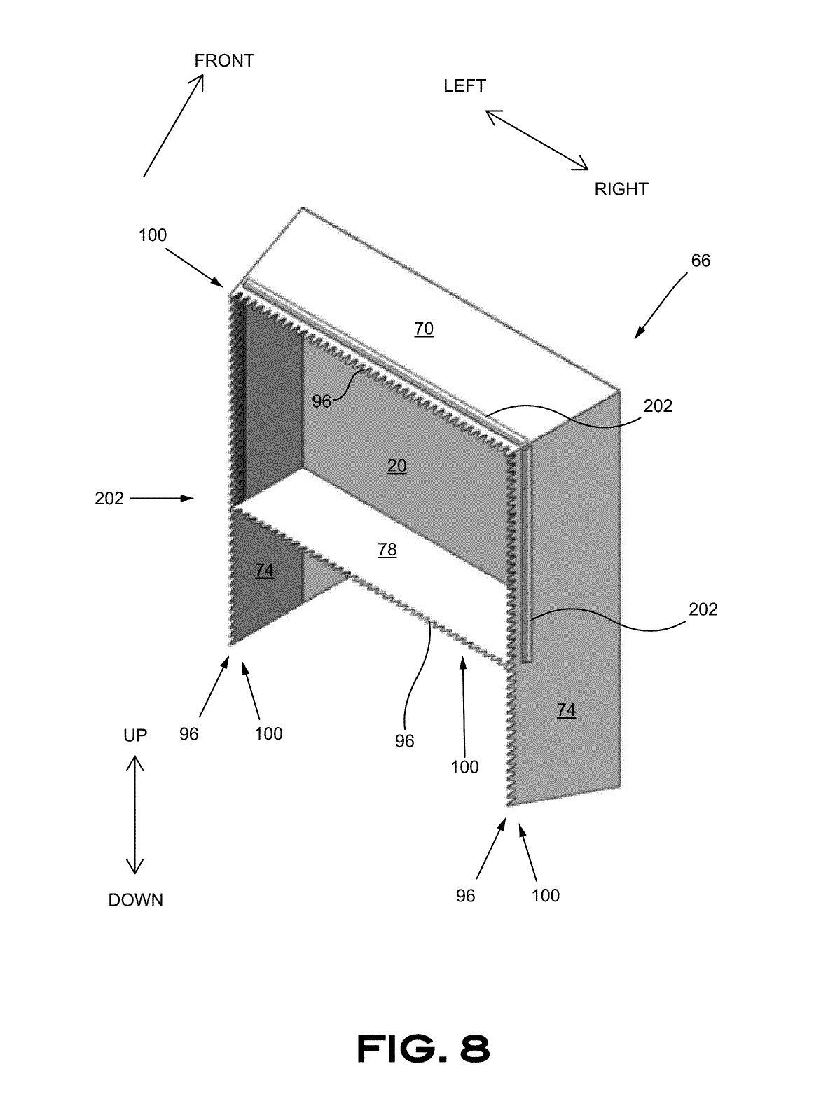

Moving to FIG. 8, illustrating an aerodynamic tail assembly 66 including an additional feature to help reduce the air drag of the road trailer 20. An elongated and protruding strip 202 is added upstream from the trailing edge 100 of the panels 70 and 74. The elongated and protruding strip 202 is used for bypassing some of the ambient air from the surrounding of the trailer to the inside/cavity of the trail to improve the mixing of low pressure and high pressure air experienced on respective sides of the aerodynamic apparatus panel members and provides at least these advantages:
Fuel consumption reduction for the tractor; breaking of one large standing vortex into multiple trailing vortices streamlined with the ambient air flow;
Arrangement around the perimeter of the tail aft can be made with straight chevron equipped members disposed in rectangular fashion; operation of trailer tail chevrons at a velocity in the range of about 40 MPH to about 80 MPH; and
Turbulence reduction around and behind the vehicle.

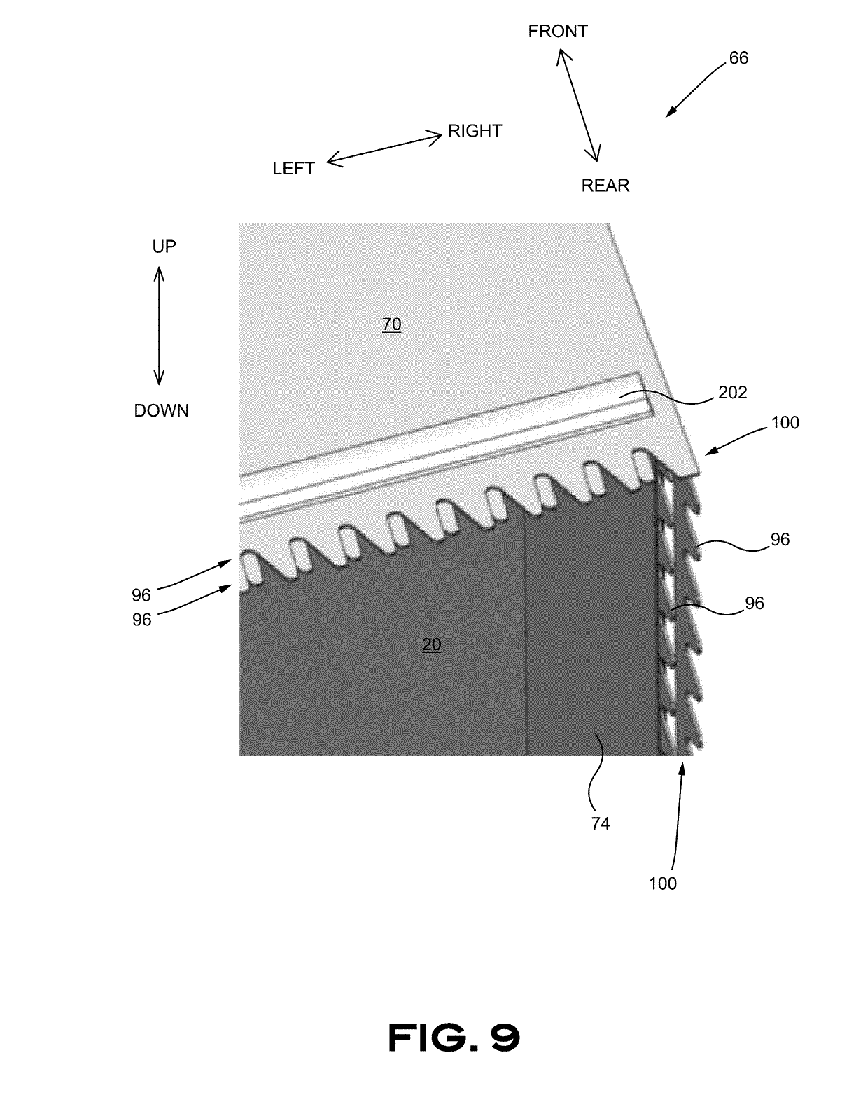

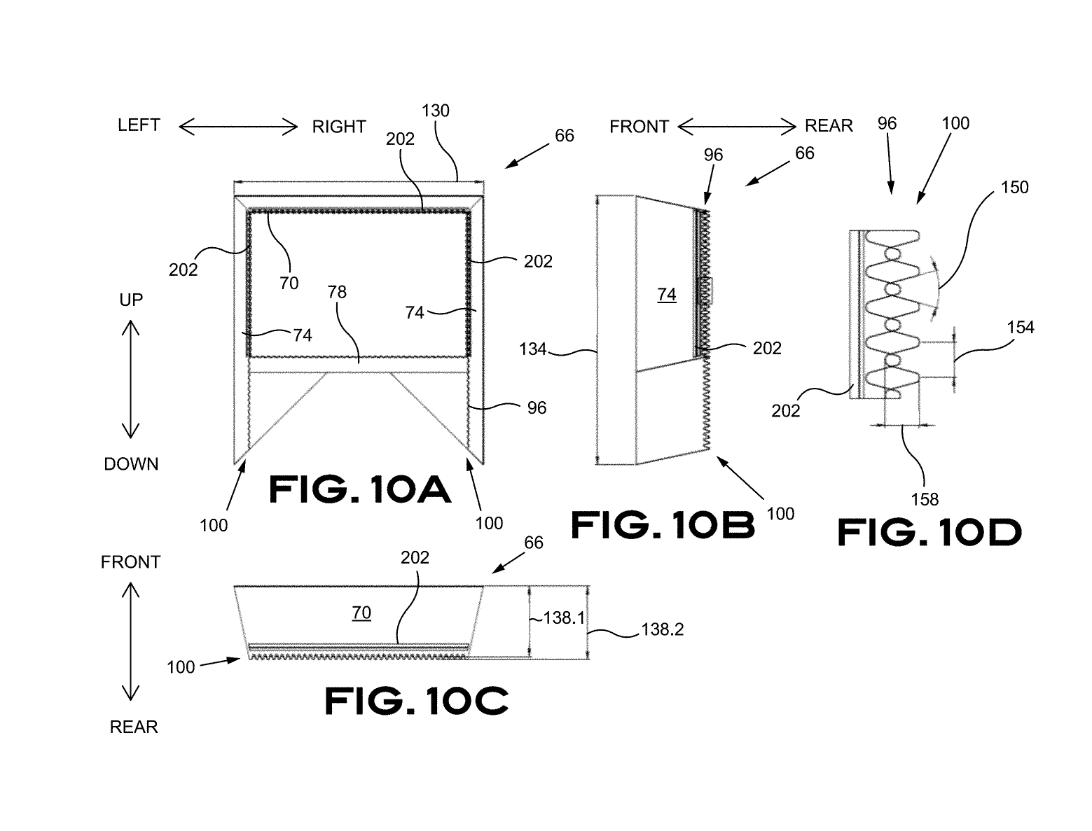

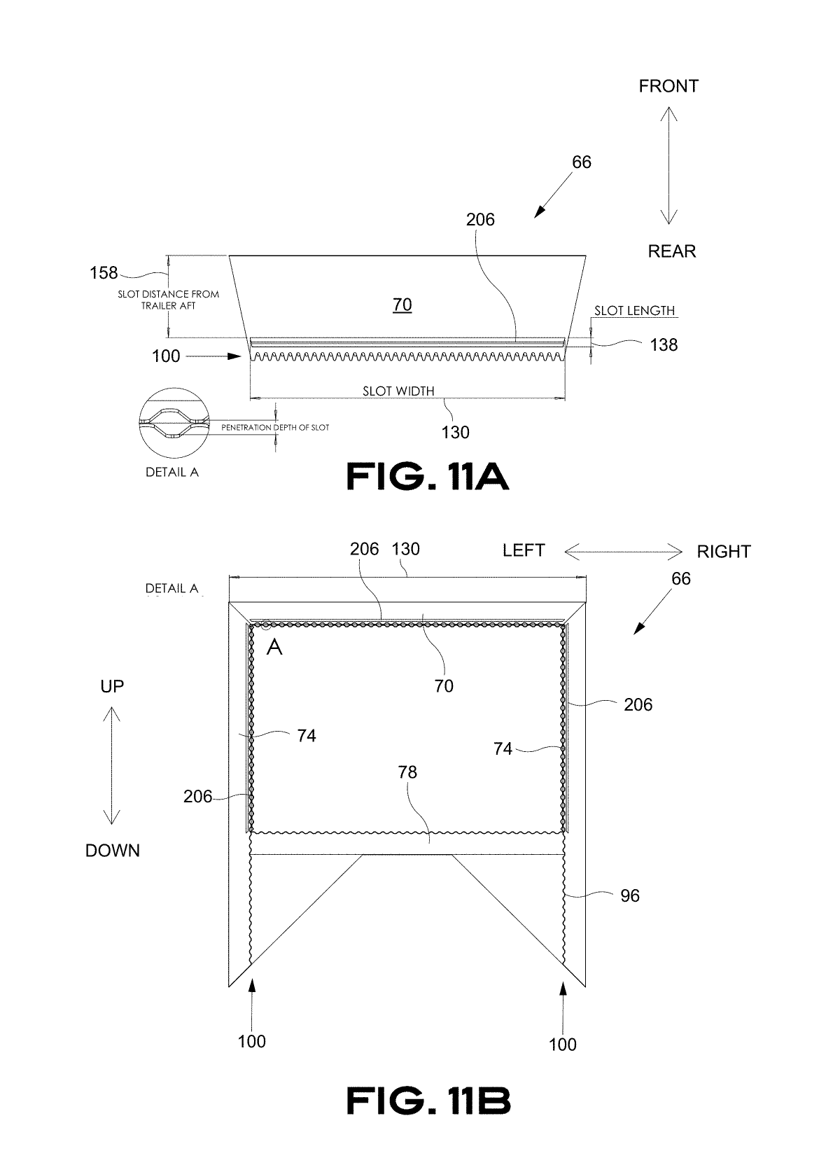

Multiple rows of serrations 96 can be used on the trailing edge 100 of the panels 70, 74, 78. They are exemplified as optionally superposed to each other with a transversal offset allowing the flow of air to be routed by two sets of serrations 96 in FIG. 9. The illustrated embodiment also optionally includes an elongated protruding strip 202 used in conjunction with the plurality of serrations 96 rows to improve the flow of air around the aerodynamic tail assembly 66. Another embodiment is exemplified in FIG. 10 with two superposed trailing edges 100 each having its own series of serrations 96. The longitudinal respective position and the transversal respective position of the series of serrations 96 illustrated in FIGS. 10A, 10B, 10C and 10D are for illustrative purposes and the respective positions could vary and remain within the scope of the present application.

The illustrated embodiment also optionally includes an elongated slot 206 used in conjunction with the plurality of serrations 96 rows to improve the flow of air around the aerodynamic tail assembly 66. Another embodiment is exemplified in FIG. 11A and FIG. 11B with two superposed trailing edges 100 each having its own series of serrations 96. The longitudinal respective position and the transversal respective position of the series of serrations 96 illustrated in FIG. 11A and FIG. 11B are for illustrative purposes and the respective positions could vary and remain within the scope of the present application. Table 3 illustrates possible embodiments associated with the elongated slot 206.

TABLE 3

| Width of | Length of | Penetration depth | Distance from |
|---|---|---|---|
| the slot | the slot | of the slot | trailer aft to slot |
| 90″ | 66 mm | 15.2 mm | 573 mm |
| 89″ | 66 mm | 25.4 mm | 508 mm |
| 90″ | 66 mm | 38.1 mm | 444 mm |
| 91.5″ | 66 mm | 50.8 mm | 381 mm |

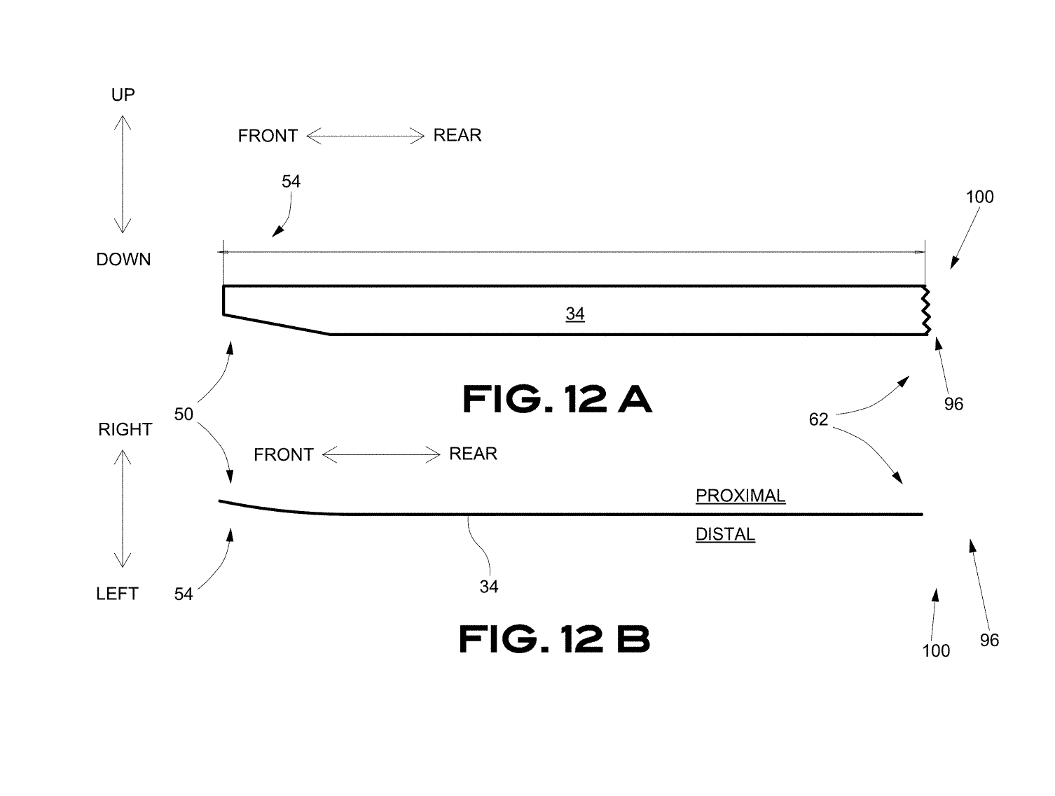

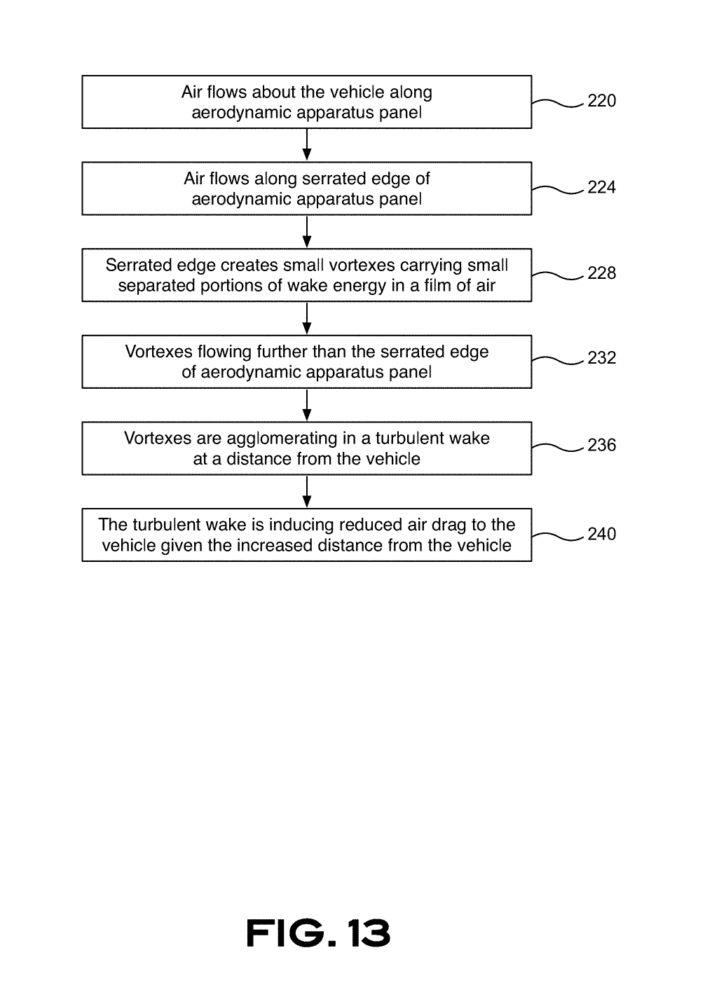

The trailing edge 100 of skirt panels 34 laterally secured on the road trailer 20 includes a series of serrations 96 for reducing the air drag of the road trailer 20. Illustrated in FIG. 12A and FIG. 12B, a skirt panel 34 is shown with a possible embodiment of the invention. The exact shape of the trailing edge of the skirt panel 34 can vary without departing from the scope of the present invention.

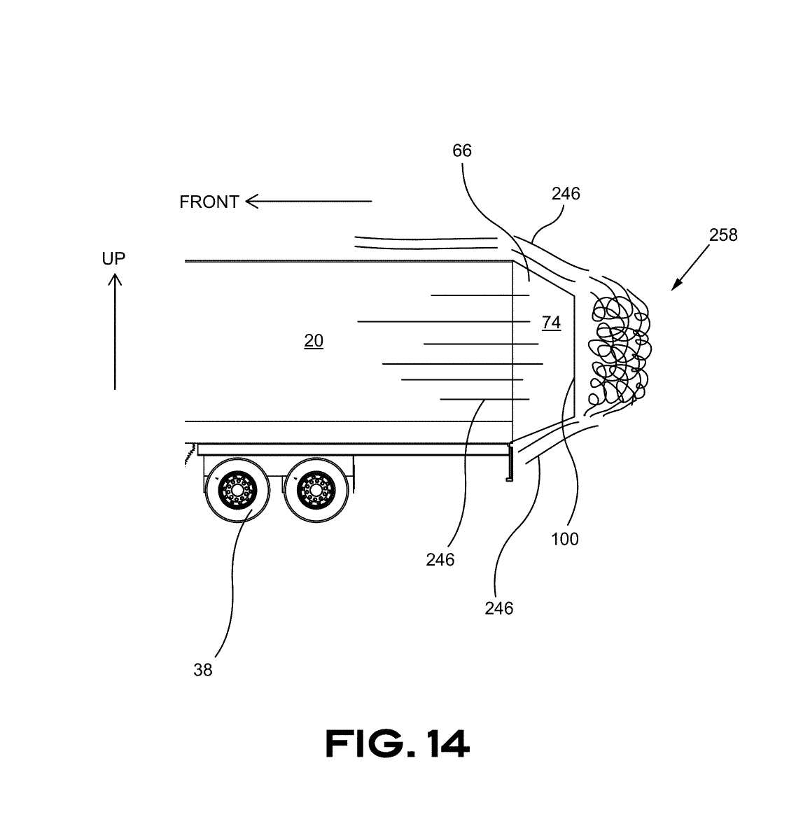

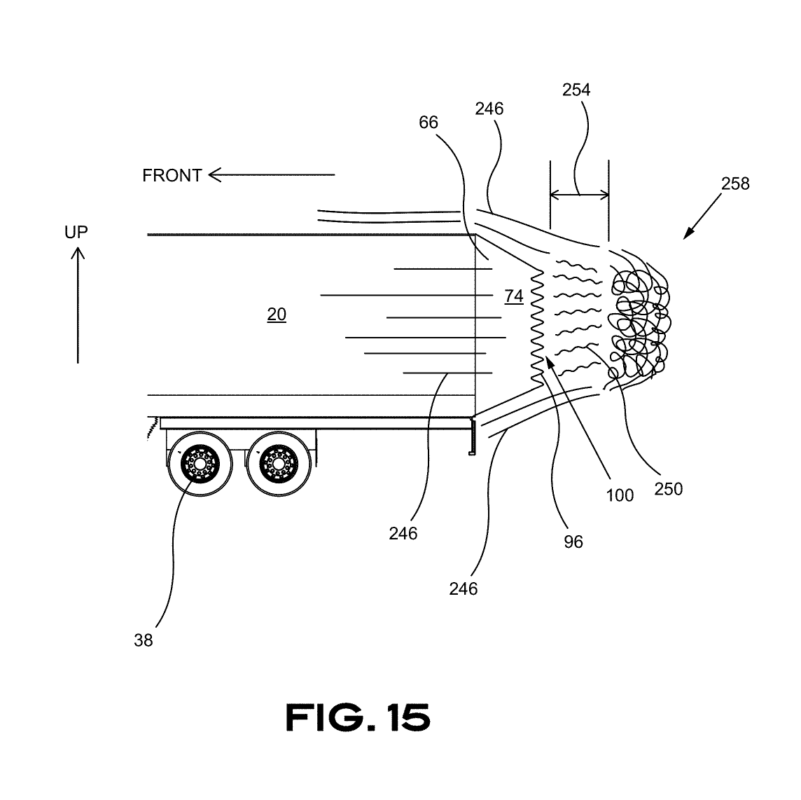

Moving now to the flow chart depicted in FIG. 14 illustrating a typical aerodynamic sequence in respect with embodiments of the invention. The air flows about the vehicle along the aerodynamic apparatus panel 220 toward the serrated edge 224 where the air flow speed difference between the rapid distal air flow 246 around the vehicle and the less rapid proximal air flow on the proximal side of the aerodynamic apparatus panel 74 is transformed into small vortexes 250 carrying the wake energy provided by the air flows speed differences by the serrated trailing edge 100 of the aerodynamic apparatus panel 228. As seen in FIG. 15, the wake energy carried by the vortexes 250 is moved further away at a distance 254 from the trailing edge 100 of the aerodynamic apparatus panel 232 and are later collectively recollecting into a generally turbulent wake 258 at a distance from the trailing edge 100 of the aerodynamic apparatus panel of the vehicle 236. The distanced turbulent wake 258 is inducing reduced air drag to the vehicle given the increased distance 254 of the wake from the vehicle 240.

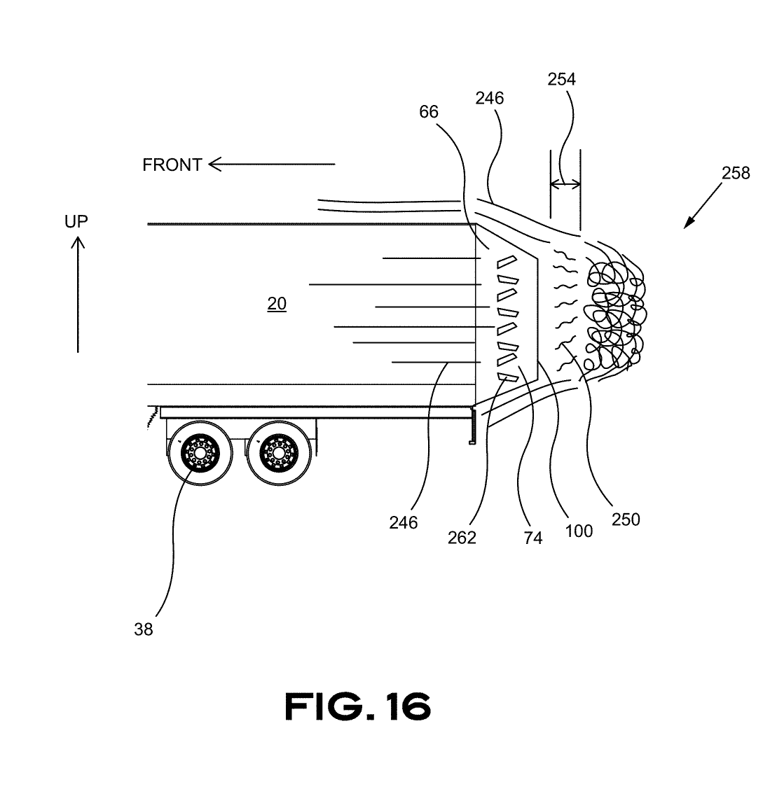

FIG. 14 shows a trailer 20 with an aerodynamic tail assembly 66 that has no serrated trailing edge 100 thereon. The turbulent wake 258 is occurring right behind the trailing edge 100 and significant air drag is created thereof. FIG. 15, in turn, shows a trailer 20 with an aerodynamic tail assembly 66 that has a serrated 96 trailing edge 100 thereon. The turbulent wake 258 is occurring at an increased distance 254 behind the trailing edge 100 and much less air drag is created thereof. Referring now to FIG. 16 where it is shown a trailer 20 with an aerodynamic tail assembly 66 that has no serrated trailing edge 100 thereon but rather vortex generators 262 protruding from the distal side of the tail assembly 66 panels (side panel 74 is better seen on FIG. 16). The turbulent wake 258 is occurring also at a distance 254 behind the trailing edge 100; less air drag is created than the embodiment of FIG. 14 although this configuration is less efficient in reducing air drag than the serrated 96 trailing edge 100 depicted in FIG. 15.

While the invention has been described in connection with what is presently considered to be the most practical and preferred embodiments, it is to be understood that the invention is not to be limited to the disclosed embodiments and elements, but, to the contrary, is intended to cover various modifications, combinations of features, equivalent arrangements, and equivalent elements included within the spirit and scope of the appended claims. Furthermore, the dimensions of features of various components that may appear on the drawings are not meant to be limiting, and the size of the components therein can vary from the size that may be portrayed in the figures herein. Thus, it is intended that the present invention covers the modifications and variations of the invention, provided they come within the scope of the appended claims and their equivalents.

What is claimed is:

1. An apparatus for reducing air drag on a vehicle, the apparatus comprising a panel including a surface thereof disposed between a first surrounding flow of air about the vehicle, on a first side of the panel, and a second surrounding flow of air about the vehicle, on a second side of the panel, the first surrounding flow of air being proximally located in respect with the longitudinal axis of the vehicle, the second surrounding flow of air being distally located in respect with the longitudinal axis of the vehicle, the first surrounding flow of air including a lower air velocity than the second surrounding flow of air, the panel including a serrated trailing edge thereof for creating vortexes and reducing air drag of the vehicle when the vehicle is moving forward.

2. The apparatus of claim 1, wherein the serrated trailing edge enables a plurality of small vortexes between the first surrounding flow of air about the vehicle and the second surrounding flow of air about the vehicle and reduce a magnitude of air flow turbulence energy.

3. The apparatus of claim 1, wherein the serrated trailing edge include a sinusoidal shape.

4. The apparatus of claim 1, wherein the serrated trailing edge include a chevron shape

5. The apparatus of claim 1, wherein the serrated trailing edge include an elongated slot upstream thereof.

6. The apparatus of claim 1, wherein the second flow of air is generally laminar.

7. The apparatus of claim 1, wherein the serrated trailing edge include a plurality of partially overlapping serrated panel portions.

8. The apparatus of claim 1, wherein the apparatus is an aerodynamic skirt.

9. The apparatus of claim 1, wherein the apparatus is an aerodynamic tail assembly.

10. A vehicle comprising an apparatus for reducing air drag on a vehicle, the vehicle comprising:
a body including at least four wheels attached thereof; and
a longitudinal axis aligned with a forward direction of the vehicle,
the apparatus comprising a panel including a surface thereof disposed between a first surrounding flow of air about the vehicle, on a first side of the panel, and a second surrounding flow of air about the vehicle, on a second side of the panel, the first surrounding flow of air being proximally located in respect with the longitudinal axis of the vehicle, the second surrounding flow of air being distally located in respect with the longitudinal axis of the vehicle, the first surrounding flow of air including a lower air velocity than the second surrounding flow of air, the panel including a serrated trailing edge thereof for creating vortexes and reducing air drag of the vehicle when the vehicle is moving forward.

11. The apparatus of claim 10, wherein the serrated trailing edge enables a plurality of small vortexes between the first surrounding flow of air about the vehicle and the second surrounding flow of air about the vehicle and reduce a magnitude of air flow turbulence energy.

12. The apparatus of claim 10, wherein the serrated trailing edge include a sinusoidal shape.

13. The apparatus of claim 10, wherein the serrated trailing edge include a chevron shape

14. The apparatus of claim 10, wherein the serrated trailing edge include an elongated slot upstream thereof.

15. The apparatus of claim 10, wherein the second flow of air is generally laminar.

16. The apparatus of claim 10, wherein the serrated trailing edge include a plurality of partially overlapping serrated panel portions.

17. The apparatus of claim 10, wherein the apparatus is an aerodynamic skirt.

18. The apparatus of claim 10, wherein the apparatus is an aerodynamic tail assembly.
